(19) United States
(12) Patent Application Publication
(10) Pub. No.: US 2026/0101008 A1
(43) Pub. Date: Apr. 9, 2026

(54) STORAGE MEDIUM STORING SERVER APPLICATION PROVIDING TROUBLESHOOTING SUPPORT SERVICE AND INFORMATION PROCESSING SYSTEM FOR PROVIDING TROUBLESHOOTING SUPPORT SERVICE

(71) Applicant: CANON KABUSHIKI KAISHA, Tokyo (JP)

(72) Inventor: Toshio OHASHI, Tokyo (JP)

(21) Appl. No.: 19/342,869

(22) Filed: Sep. 29, 2025

(30) Foreign Application Priority Data
Oct. 3, 2024 (JP) 2024-174550

(51) Int. Cl. H04N 1/00; G06F 11/07; G06F 11/14

(52) U.S. Cl. CPC H04N 1/00037; G06F 11/0733; G06F 11/1438

(57) ABSTRACT

It is possible to realize a necessary solution in troubleshooting support by using generative AI without a hitch. A generative AI application providing the troubleshooting support for a device obtains a solution method for solving trouble occurring in the device and receives, in a case where a first user who is involved in the trouble is unable to handle the solution method on the first user's own, an instruction for proxy asking from the first user. Further, the generative AI application requests, based on the received instruction, a second user different from the first user to execute the solution method as a proxy.

### BACKGROUND

### Field of the Technology

The present disclosure relates to a technique of diagnosing a device by using generative AI.

### Description of the Related Art

In recent years, cases where troubleshooting support for an electronic device such as an MFP is provided by utilizing functions such as contextual understanding and information extraction which are achieved by using an AI technology have been increasing. For example, Patent Document 1 No. U.S. Pat. No. 11,960,907 discloses a technique of diagnosing and predicting trouble by using AI by using telemetry data on a device and then changing the settings of the device based on diagnosis and prediction results. Further, “Copilot,” a generative AI tool provided by Microsoft Corporation, realizes troubleshooting support in cooperation with a general application such as Word.

### SUMMARY

A generative AI application providing troubleshooting support for a device according to the present disclosure includes obtaining a solution method for solving trouble occurring in the device, receiving, in a case where a first user involved in the trouble who receives presentation of the solution method is unable to handle the solution method on the first user's own, an instruction for proxy asking for the solution method from the first user, and requesting, based on the received instruction, a second user different from the first user to execute the solution method as a proxy.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram describing a system configuration and a hardware configuration of a device diagnosis system.

FIG. 2 is a block diagram describing a software configuration of the device diagnosis system according to Embodiment 1.

FIGS. 3A to 3E are diagrams illustrating an example of a table placed under the management of a database module.

FIG. 4 is a sequence diagram illustrating the flow of operations of the device diagnosis system according to Embodiment 1.

FIG. 5 is a diagram illustrating an example of a UI screen on which a generative AI client application provides troubleshooting support.

FIG. 6 is a diagram illustrating an example of the UI screen on which the generative AI client application provides the troubleshooting support.

FIG. 7 is a block diagram describing a software configuration of a device diagnosis system according to Embodiment 2.

FIG. 8 is a sequence diagram illustrating the flow of operations of the device diagnosis system according to Embodiment 2.

FIG. 9 is a diagram illustrating an example of a UI screen on which a generative AI client application provides troubleshooting support.

FIG. 10 is a diagram illustrating an example of the UI screen on which the generative AI client application provides the troubleshooting support.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

There is a case where the cooperation of a person other than a user who is involved in trouble is required to execute a solution (actions) necessary to solve (address) the trouble in troubleshooting support for a device which is provided by utilizing generative AI For example, there are the following cases: a user does not have the authority necessary to change settings of a target device and operate the target device; an operation performed by a technical support person having expert knowledge is required; and a user has a situation in which the user has difficulty in directly accessing the target device on the user's own, or the like. Then, the inventor of the present application understands from the consideration of the cases that the necessary actions to address the trouble cannot be realized in a case where the above situations are encountered in conventional troubleshooting support which is provided by using generative AI.

### First Embodiment

In the present embodiment, as an example of a device diagnosis system, an explanation is made by taking, as an example, a case where an MFP (Multifunction Peripheral) generally referred to as a multifunctional printer is diagnosed by a diagnosis service and a generative AI service which operate on the cloud. Incidentally, a device to be diagnosed is not limited to the MFP but may be an electronic device specialized in a particular function such as a printer, a FAX, and a scanner.

### <System Configuration/Hardware Configuration>

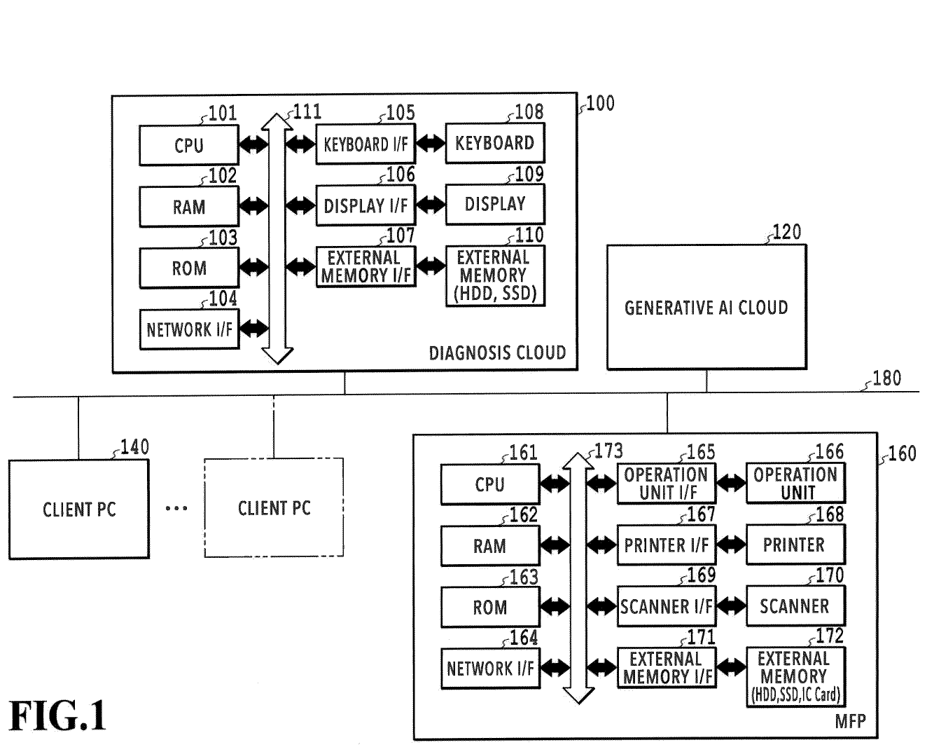

FIG. 1 is a block diagram describing a system configuration and a hardware configuration of a device diagnosis system according to the present embodiment.

The device diagnosis system includes a diagnosis cloud 100, a generative AI cloud 120, a client computer 140, and an MFP 160, and the diagnosis cloud 100, the generative AI cloud 120, the client computer 140, and the MFP 160 are mutually connected via a network 180.

A CPU 101 of the diagnosis cloud 100 is an arithmetic processing apparatus which totally controls each device connected to a system bus 111 and executes an application program or the like stored in a ROM 103 or an external memory 110. Further, the CPU 101 opens various windows registered based on a command instructed by a mouse cursor (not illustrated) or the like on a display 109 and executes various data processes. The RAM 102 functions as a main memory and a work area or the like of the CPU 101. The ROM 103 is a read-only memory functioning as a storage area of a basic I/O program or the like. In the ROM 103 or the external memory 110, an operating system program (hereinafter referred to as “OS”) or the like which is a control program of the CPU 101 is stored. Furthermore, in the ROM 103 or the external memory 110, files or various other pieces of data to be used in the execution of the application program or the like are stored. A network I/F 104 is an interface connecting with a network 180 and then communicating with an external apparatus. A keyboard I/F 105 is an interface controlling input from a keyboard 108 and a pointing device (not illustrated). A display I/F 106 is an interface controlling the display of the display 109. An external memory I/F 107 is an interface controlling access to the external memory 110 such as a hard disk drive (HDD) and a solid state drive (SSD). The external memory 110 includes the HDD and the SSD and stores a boot program, various applications, a user file, and an edit file or the like. The diagnosis cloud 100 operates in a state where the CPU 101 executes a basic I/O program and an OS written to the ROM 103 and the external memory 110. The basic I/O program is written to the ROM 103, and the OS is written to the ROM 103 or the external memory 110. Further, in a case where a computer is turned on, by an initial program load function in the basic I/O program, the OS is written to the RAM 102 from the ROM 103 or the external memory 110, and the operation of the OS starts. The system bus 111 is a bus connecting each device. Incidentally, hardware resources such as the CPU 101, the ROM 103, the external memory 110 or the like constituting the diagnosis cloud 100 are supplied on demand by a virtualization technique. As a result of these hardware resources being supplied on demand by the virtualization technique, the diagnosis cloud 100 is configured as a virtual server in a cloud computing environment.

The hardware configurations of a generative AI cloud 120 and a client computer (hereinafter referred to as “client PC”) 140 are the same as the hardware configuration of the diagnosis cloud 100, and thus a description thereof is omitted.

In the MFP 160, a CPU 161 is an arithmetic processing apparatus which totally controls each device connected to a system bus 173 and executes a control program or the like corresponding to each function. For example, in a case where a user uses a printer function, a printer control program is executed to output an image signal as output information to a printer 168 via a printer I/F 167. Incidentally, the control program is stored in a ROM 163, an external memory 172, or the like. Further, the CPU 161 communicates with an external apparatus via a network l/F 164. Furthermore, the CPU 161 performs various processes based on an application program or the like stored in the ROM 163 or the external memory 172. The RAM 163 functions as a main memory and a work area or the like of the CPU 161 and is configured so that memory capacity can be expanded by an option RAM connected to an extension port (not illustrated). Incidentally, the RAM 162 is used for an output information expansion area, and an environment data storage area or the like. The ROM 163 is a read-only memory functioning as a storage area such as a basic 1/0 program or the like. The ROM 163 or the external memory 172 stores a control program and an application program of the CPU 161 and font data to be used in a case of the generation of the output information, and information to be used in the MFP 160. An operation unit I/F 165 is an interface with an operation unit 166 and outputs image data to be displayed to the operation unit 166 and receives information input by the user via the operation unit 166, or the like. The operation unit 166 includes, for example, an operation panel or the like on which a switch and an LED or the like for user operations are arranged. The printer I/F 167 is an interface which outputs an image signal as the output information to the printer 168 (printer engine). A scanner l/F 169 is an interface which receives an image signal as input information from a scanner 170 (scanner engine). An external memory I/F (memory controller) 171 is an interface which controls access to an external memory 172 such as a hard disk drive (HDD) and an IC card. Incidentally, the number of the external memories 172 is not limited to one, but a plurality of the external memories 172 are connected. Further, the MFP 160 may have an NVRAM (not illustrated) and store printer mode setting information from the operation unit 166. The system bus 173 is a bus which connects each device.

### <Software Configuration>

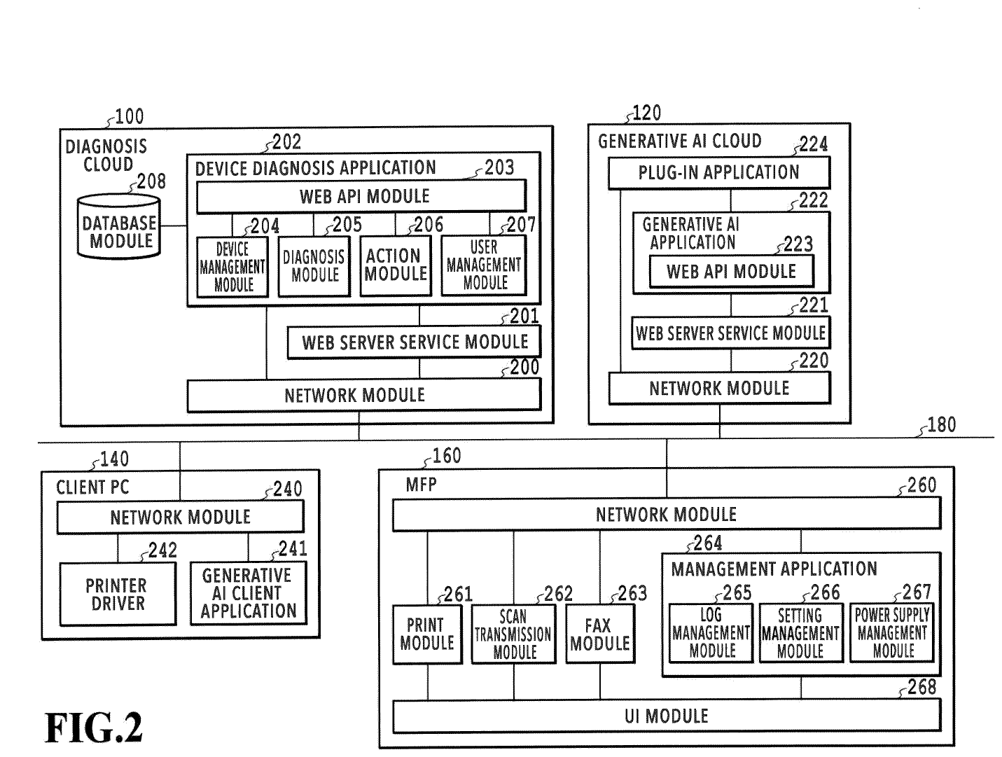

FIG. 2 is a block diagram describing a software configuration of the device diagnosis system according to the present embodiment. Hereinafter, the software configuration of the device diagnosis system is described with reference to FIG. 2.

### <<Software Configuration of Diagnosis Cloud>>

First, the software configuration of the diagnosis cloud 100 is described. The diagnosis cloud 100 includes a network module 200, a Web server service module 201, a device diagnosis application 202, and a database module 208. Further, these constituent elements exist as files stored in the external memory 110. In other words, these constituent elements are program modules which are loaded into the RAM 102 by the OS and a module which uses a module of the OS in a case of the execution of the program modules and which are then executed. Further, the device diagnosis application 202 can be added to the HDD and the SSD of the external memory 110 supplied on demand by the virtualization technique in the cloud computing environment.

A network module 200 performs network communication with the generative AI cloud 120 and the MFP 160 by using any communication protocol. A Web server service module 201 provides service in which an HTTP request is received from a plug-in application 224 of the generative AI cloud 120 and an HTTP response is returned. In a case where the HTTP response is returned, the Web server service module 201 may request the generation of an HTTP response of the device diagnosis application 202.

The device diagnosis application 202 is an application taking action according to the diagnosis of the MFP 160 and a diagnosis result via the network 180. The device diagnosis application 202 is implemented as, for example, a program performing a process in response to a request to a Web API provided by the Web server service module 201. The device diagnosis application 202 realizes, together with the Web server service module 201, a cloud service in which the action according to the diagnosis of the MFP 160 and the diagnosis result is taken. The device diagnosis application 202 has a Web API module 203, a device management module 204, a diagnosis module 205, an action module 206, and a user management module 207. The Web API module 203 generates an HTTP response by calling a necessary module based on a request from the Web server service module 201. Each of the device management module 204, the diagnosis module 205, the action module 206, and the user management module 207 is an example of a module to be called by the Web API module 203. However, the Web API module 203 may call a module other than the above modules. The device management module 204 obtains device information indicating the ID and the status of a target device from the target device (here, the MFP 160) and log information indicating a job history via the network module 200. Incidentally, the obtainment of the device information and the log information is performed by push communication from the MFP 160 and polling from the diagnosis cloud 100 by using any communication protocol. An HTTPS (Hypertext Transfer Protocol Secure) or the like is given as an example of a communication protocol. The device management module 204 stores the device information and the log information obtained from the MFP 160 in a device information table and a log table managed by the database module 208 mentioned below. Further, the device management module 204 retrieves information from the device information table and the log table as necessary. The diagnosis module 205 obtains information necessary for a diagnosis from a plurality of tables in the database module 208 mentioned below and diagnoses trouble (failure and problem) occurring in the target device. The diagnosis result is returned as an HTTP response via the Web API module 203. The action module 206 takes action to solve trouble occurring in the target device based on the diagnosis result obtained from the diagnosis module 205. The result of the action is sent as an HTTP response via the Web API module 203. Action to be taken by the action module 206 includes, for example, the provision of instructions to change the settings of the target device and to reboot the target device. The action module 206 provides instructions, by using any communication protocol, to change the settings of the target device and to reboot the target device via the network module 200. Examples of a communication protocol used by the action module 206 include, in addition to the HTTPS mentioned above, XMPP, MQTT, and AMQR or the like. Here, XMPP is an abbreviation for “Extensible Messaging and Presence Protocol.” MQTT is an abbreviation for “Message Queuing Telemetry Transport.” AMQP is an abbreviation for “Advanced Message Queuing Protocol.” The user management module 207 receives a request to check the authority of the user who inquiries about the trouble and returns information on the authority which the user has as an HTTP response via the Web API module 203. In that case, necessary information is obtained from the user table 303 and the authority table 304 in the database module 208 mentioned below and a response is made. The database module 208 manages various pieces of data and stores and retrieves data in response to a request from another module. The database module 208 may be an external module which is accessible from the device diagnosis application 202 and may be realized as, for example, a database in another cloud computing environment.

### <<Software Configuration of Generative AI Cloud>>

Next, the software configuration of the generative AI cloud 120 is explained. The generative AI cloud 120 includes a network module 220, the Web server service module 201, a generative AI application 222, and the plug-in application 224. Further, these constituent elements exist as files stored in the external memory 110. In other words, these constituent elements are program modules which are loaded into the RAM 102 by the OS and a module which uses a module of the OS in a case of the execution of the program modules and which are then executed. Further, the generative AI application 222 and the plug-in application 224 can be added to the HDD and the SSD of the external memory 110 supplied on demand by the virtualization technique in the cloud computing environment. The network module 220 performs network communication with the diagnosis cloud 100 and the client PC 140 by using any communication protocol. The Web server service module 221 provides service in which an HTTP request from a generative AI client application 241 of the client PC 140 is received and an HTTP response is returned. The Web server service module 221 may request the generative AI application 222 to generate an HTTP response in a case where the HTTP response is returned. The generative AI application 222 is an artificial intelligence system application which generates a response by using a Large Language Model (LLM) or the like for any piece of text information input by the user. The generative AI application 222 is implemented as, for example, a program executing a process in response to a request to the Web API provided by the Web server service module 221. The generative AI application 222 realizes a generative AI cloud service together with the Web server service module 221. The generative AI application 222 has the Web API module 223. The Web API module 223 generates the HTTP response by calling the necessary module based on the request from the Web server service module 221. The plug-in application 224 is an application which adds a particular function to the generative AI application 222 and performs the particular function by a plug-in mechanism of the generative AI application 222. In the present embodiment, a remote diagnosis function which the diagnosis cloud 100 has is added to the generative AI application 222 by the plug-in application 224. The cooperation of the plug-in application 224 with the device diagnosis application 202 of the diagnosis cloud 100·is realized by the sending and receiving of an HTTP request message and a HTTP response message. The plug-in application 224 sends the HTTP request message to the Web API module 203 of the diagnosis cloud 100 via the network module 220 and receives the HTTP response message returned from the diagnosis cloud 100.

### <<Software Configuration of Client PC>>

Next, the software configuration of the client PC 140 is described. The client PC 140 includes a network module 240, the generative AI client application 241, and a printer driver 242. Further, these constituent elements exist as files stored in the external memory 110. In other words, these constituent elements are program modules which are loaded into the RAM 102 by the OS and a module which uses a module of the OS in a case of the execution of the program modules and which are then executed. The network module 240 performs network communication with the generative AI cloud 120 and the MFP 160 by using any communication protocol. The generative AI client application 241 sends an HTTP request message to the generative AI cloud 120 via the network module 240 and receives an HTTP response message from the generative AI cloud 120 and displays the HTTP response message. The generative AI cloud 120 is accessed from the client PC 140 through the generative AI client application 241. The printer driver 242 creates a print job which is print instruction data and sends the print job to the MFP 160 via the network module 240. Further, the printer driver 242 receives execution results of the print job from the MFP 160 via the network module 240 and displays the execution results.

### <<Software Configuration of MFP>>

Next, the software configuration of the MFP 160 is described. The MFP 160 includes a network module 260, a print module 261, a scan transmission module 262, a FAX module 263, a management application 264, and a UI module 268. Further, these constituent elements exist as files stored in the ROM 163 or the external memory 172 and are loaded into the RAM 162 in a case of the execution of the constituent elements and are then executed. The network module 260 performs network communication with the diagnosis cloud 100 and the client PC 140 by using any communication protocol. The print module 261 receives a print job transmitted from the printer driver 242 of the client PC 140 via the network module 260 and performs a print process according to the print job. Further, the print module 261 creates log information on a print job which has been executed and transmits the log information to a log management module 265. The scan transmission module 262 generates and executes a scan job and a scan data transmission job based on a scan instruction received from a user via the UI module 268 mentioned below. Here, for the transmission of the scan data, a protocol of, for example, an e-mail or SMB (Server Message Block) is used. Further, the scan transmission module 262 creates log information on the scan job which has been executed and the scan data transmission job and transmits the log information to the log management module 265. The FAX module 263 receives a FAX reception job from a Fax device (not illustrated) or the like via the network module 260. The received FAX reception job is printed via the print module 261 and is transferred to another MFP or the like via the network module 260. In addition, the FAX module 263 generates and executes a FAX transmission job based on a FAX transmission instruction received from the user via the UI module 268. Furthermore, the FAX module 263 creates log information on the FAX reception job and the FAX transmission job which have been executed and then transmits the log information to the log management module 265. The management application 264 includes the log management module 265, a setting management module 266, and a power supply management module 267. The log management module 265 receives an obtainment request for device information/log information from the device management module 204 of the diagnosis cloud 100 via the network module 260 and returns the device information and the log information. The setting management module 266 is a module which manages setting values in various settings of the MFP 160. The setting management module 266 performs, based on instructions to confirm settings and change the settings which are received from the user via the UI module 268, a process of returning and changing setting values according to the instructions. Furthermore, the setting management module 266 receives an instruction to change the settings transmitted from the action module 206 of the diagnosis cloud 100 via the network module 260 and changes setting values of the settings according to the instruction to change the settings. The power supply management module 267 is a module which manages the power supply state of the MFP 160. The power supply management module 267 turns off or reboots the power supply of the MFP 160 based on an instruction to turn off or reboot the power supply received from the user via the UI module 268. Furthermore, the power supply management module 268 receives an instruction to turn off or reboot the power supply transmitted from the action module 206 of the diagnosis cloud 100 via the network module 260 and turns off or reboots the power supply of the MFP 160. The UI module 268 receives drawing on a UI screen displayed on the operation unit 166 of the MFP 160 and a user instruction on the operation unit 166.

### <Example of Table Managed by Database Module>

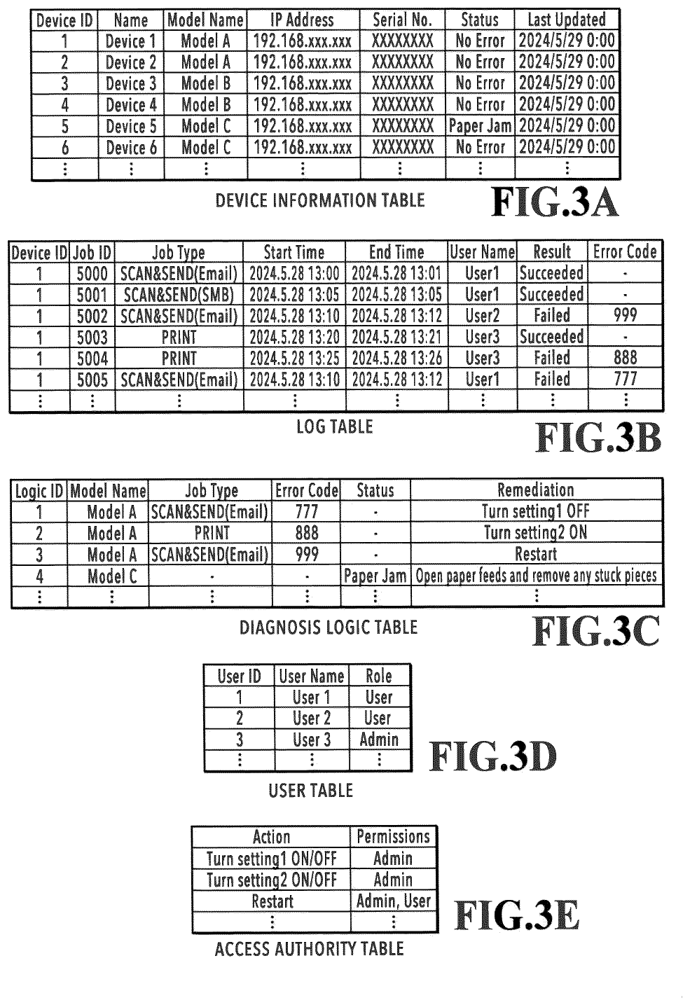

Subsequently, various tables which are managed by the database module 208 of the diagnosis cloud 100 are described. FIGS. 3A to 3E show an example of a table placed under the management of the database module 208.

FIG. 3A shows a device information table storing information on a diagnosis target device (here the MFP 160). The device information table in FIG. 3A includes each of the items “Device ID,” “Device Name,” “Model Name,” “IP Address,” “Serial No.,” “Status,” and “Last Updated.” Here, in “Device ID,” an identifier by which the target device can be uniquely identified is entered. In “Device Name” and “Model Name,” the name and the model name of the target device are entered, respectively. In “IP Address,” an IP address allocated to the target device is entered, and in “Serial No.,” the serial number of the target device is entered. In “Status,” information indicating the state of the target device is entered, and in “Last Updated,” information indicating the date and time at which a record was updated last is entered.

FIG. 3B shows a log table storing log information which the device management module 204 obtains from the target device. The log table in FIG. 3B includes each of the items “Device ID,” “Job ID,” “Job Type,” “Start Time,” “END Time,” “User Name,” “Result,” and “Error Code.” Here, an identifier by which the target device can be uniquely identified and an identifier by which a target job can be uniquely identified are entered in “Device ID” and “Job ID” respectively. In “Job Type,” information indicating the type of job is entered. In “Start Time” and “END Time,” information on a job execution start date and time and information on a job execution end date and time are entered. In “User Name,” the user name of a user who provides an instruction to execute a job is entered, and in “Result,” information indicating whether the execution of the job is successful or has failed, and in “Error Code,” an error code in a case where the execution of the job has failed is entered. Here, the job refers to an execution command generated in a case where the MFP 160 executes printing, scan transmission, facsimile or the like and the job identifier is an identifier which identifies the job uniquely. Further, the error code is a code to identify the cause of an error of the job uniquely.

FIG. 3C shows a table storing a diagnosis logic to be used in a case where the diagnosis module 205 performs a diagnosis. The diagnosis logic table in FIG. 3C includes each of the items “Logic ID,” “Model Name,” “Job Type,” “Error Code,” “Status,” and “Remediation.” Here, an identifier by which each logic can be uniquely identified is entered in “Logic ID,” and the model name of the target device is entered in “Model Name.” In “Job Type,” information indicating the type of job is entered. In “Error Code,” an error code in a case of a job failure is entered. In “Status,” information indicating the state of the target device is entered, and in “Remediation,” a solution method for solving the trouble (that is, the contents to be handled for each failure or problem which a model name, a job type, an error code in a case of a job failure, and a status match) is entered.

FIG. 3D shows a user table storing information on each user of the diagnosis cloud. The user table in FIG. 3D includes each of the items “User ID,” “User Name,” and “Role.” In “User ID,” an identifier by which each user can be uniquely identified is entered, in “User Name,” the name of a user is entered, and in “Role,” information indicating an attribute as to whether the user is a general user or an administrator is entered.

FIG. 3E shows an authority table storing information on the authority of each user of the diagnosis cloud. The authority table in FIG. 3E includes two items: “Action” and “Permissions.” In “Action,” information indicating the contents of a function and an operation is entered, and in “Permissions,” information indicating a user attribute necessary for the function and the operation is entered. Incidentally, the authority table in FIG. 3E is a table storing authority information in units of users of the diagnosis cloud but may be a table storing authority information in units of users of the MFP 160, for example. Further, the diagnosis cloud 100 may obtain user information and authority information which the MFP 160 internally manages and manage the user information and the authority information as tables. Furthermore, the respective tables shown in FIGS. 3A to 3E are only examples, and for example, information different from the above examples may be stored in the respective tables, and a table different from the respective tables shown in FIGS. 3A to 3E may exist.

### <Operation Sequence of Device Diagnosis System>

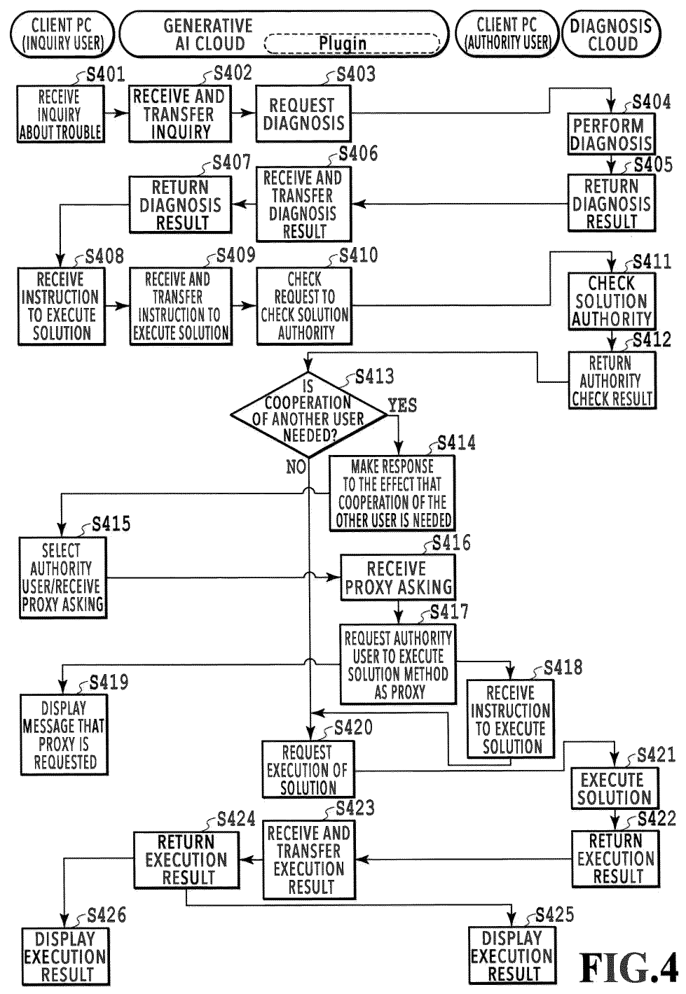

Next, the operations of the device diagnosis system according to the present embodiment are described by using a sequence diagram in FIG. 4. Here, an explanation is made by giving, as an example, a situation in which a user who attempts to perform external transmission (scan transmission) of a scan image of a document in the MFP 160 but fails to do so troubleshoots by using generative AI Incidentally, the symbol “S” in the following descriptions means a step.

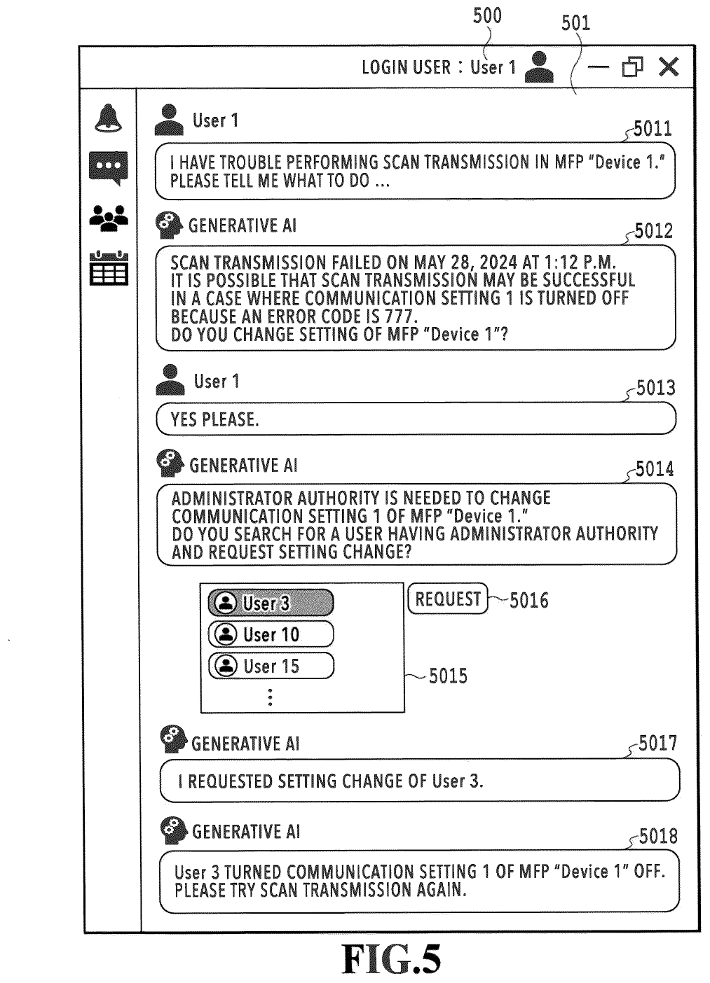

In S401, the generative AI client application 241 of the client PC 140 receives input of an inquiry (prompt) about the trouble occurring in the MFP 160 and transmits the inquiry to the generative AI cloud 120. A user who makes an inquiry logs in the generative AI cloud 120 from the client PC 140 and inputs inquiry contents in the form of text information via a UI screen displayed by the generative AI client application 241. FIG. 5 shows an example of a user interface screen (UI screen) on which the generative AI client application 241 provides troubleshooting support and “User 1,” the user name of the user who logs in, is displayed in a user name area 500. Further, at the time of the present step, text information 5011 on the inquiry contents input by the user is displayed in a prompt area 501 of the UI screen in FIG. 5. Incidentally, the user who makes the inquiry is referred to as “inquiry user” in the following descriptions.

In S402, the generative AI application 222 of the generative AI cloud 120 receives an inquiry (prompt) from the client PC 140 and transfers the inquiry to the plug in application 224. Further, in S403, the plug-in application 224 transmits a diagnosis request to diagnose the inquiry received from the generative AI application 222 to the diagnosis cloud 100.

In S404, the device diagnosis application 202 of the diagnosis cloud 100 which receives the request performs a diagnosis of the inquiry. Specifically, first, the device diagnosis application 202 refers to the log table of the database module 208 via the device management module 204 and then identifies a job to be diagnosed. In the above specific example, a job of “Scan and Send (Email)” in which an execution error occurs is identified by the user name of the inquiry user “User 1.” In a case where the job to be diagnosed is identified, the device diagnosis application 202 refers to the diagnosis logic management table 302 of the database module 208 via the diagnosis module 205 and then obtains a solution method associated with the identified job. In the above specific example, the solution method to “turn off communication setting 1” corresponding to the error code “777” is obtained. In a case where the diagnosis result is obtained thereby, in S405, the device diagnosis application 202 responds to the generative AI cloud 120 which has requested a diagnosis by returning the diagnosis result (an error log of the job relating to the inquiry and a solution method thereof).

In S406, the plug-in application 224 of the generative AI cloud 120 receives the diagnosis result and transfers the diagnosis result to the generative AI application 222. Further, in S407, the generative AI application 222 responds to a client PC 140 of the inquiry user by returning the diagnosis result received from the plug-in application 224.

In S408, the generative AI client application 241 of the client PC 140 presents the contents of the diagnosis result received from the generative AI cloud 120 to the inquiry user. Specifically, the error log of the diagnosis target job and the solution method thereof included in the diagnosis result are displayed on the UI screen at which the inquiry user looks. In the above specific example, a message 5012 to the effect that trouble is a scan transmission error and the error code of the scan transmission error is “777” and that “turning off communication setting 1” is suggested as a solution method is displayed in the prompt area 501 in FIG. 5. Furthermore, in a case where the inquiry user wishes the execution of the suggested solution method, the inquiry user inputs text information 5013 to that effect. The generative AI client application 241 which receives such a user instruction transmits an instruction to execute a solution to the generative AI cloud 120.

In S409, the generative AI application 222 of the generative AI cloud 120 receives the instruction to execute the solution from the client PC 140 of the inquiry user and transfers the instruction to execute the solution to the plug-in application 224. Further, in S410, the plug-in application 224 transmits to the diagnosis cloud 100 a check request to check whether it is possible to execute the solution method included in the diagnosis result received in S406 by the authority of the inquiry user.

In S411, the device diagnosis application 202 of the diagnosis cloud 100 which receives the check request to check the execute authority checks the execute authority of the inquiry user via the user management module 207 and the database module 208. Specifically, the user table and the authority table shown in FIGS. 3D and 3E mentioned above are referred to, and whether the inquiry user has the execute authority to execute the solution method according to the instruction to execute the solution is checked. Here, what “User 1” who is the inquiry user has is only general user authority, and it is found that the administrator authority is required for the solution method according to the instruction to execute the solution to “turn off communication setting 1.” Furthermore, a user who has the administrator authority (hereinafter referred to as “authority user”) is also searched for, and for example, “User 3” is identified as an authority user. In subsequent S412, the device diagnosis application 202 responds to the generative AI cloud 120 which has requested a check by returning a check result of checking the execute authority. Here, the check result which shows that “User 1” who is the inquiry user does not have the authority to turn “communication setting 1 off” which is the solution method and that “User 3” or the like has the execute authority to turn “communication setting 1 off” are transmitted to the generative AI cloud 120.

In S413, the plug-in application 224 of the generative AI cloud 120 receives the check result of checking the execute authority and determines based on the check result whether the cooperation of another user is necessary. Further, based on the determination result, a process to be performed next proceeds to S414 or S420. In a case where the inquiry user does not have the execute authority, a response (S414) to the effect that handling performed by the authority user who has the execute authority is necessary is returned next. On the other hand, in a case where the inquiry user has the execute authority, an execution request (S420) to execute the solution method is made next. In the above specific example, since “User 1” who is the inquiry user does not have administrator authority necessary for the solution method to “turn off communication setting 1,” it is determined that the handling performed by the authority user is necessary, and S414 is performed.

In S414, the plug-in application 224 makes a response to the effect that the handling performed by the authority user is necessary to the client PC 140 of the inquiry user. In S415, the generative AI client application 241 of the client PC 140 of the inquiry user, based on the response from the generative AI cloud 120, displays information to the effect that the handling performed by the authority user is necessary on the UI screen and receives an instruction for proxy asking. Specifically, the one or more user names of one or more authority users included in the received response are displayed on the UI screen in list form, and the inquiry user is made to select whether the inquiry user requests the authority user to execute the solution method as a proxy. In the above specific example, a list 5015 of the user names of selectable authority users is displayed in the prompt area 501 of FIG. 5 together with a message 5014 to the effect that the administrator authority is necessary for the execution of the solution method. Furthermore, on the right side of the list display, a “request” button 5016 in a case where the authority user is requested to act as a proxy is also displayed. The inquiry user can make a request to another user (here “User 3” is selected) which has the execute authority to execute the solution method via such a UI screen. Incidentally, in a case where authority users which are selection candidates are displayed in list form, an authority user who does not log in the generative AI cloud 120 may be grayed out and made unselectable or may be excluded from the list. Further, setting may be made so that whether the environment of the selected authority user is reliable in terms of security is verified, and only in a case where it is confirmed that the environment is reliable in terms of security, the “request” button is displayed. In this way, in a case where an instruction for proxy asking for the solution method is received from the inquiry user, the generative AI client application 241 transmits proxy asking to the generative AI cloud 120.

In S416, the plug-in application 224 of the generative AI cloud 120 receives the proxy asking from the client PC 140 of the inquiry user. In subsequent S417, the plug-in application 224 transmits to the client PC 140 of the authority user designated by the received proxy asking, information to the effect that the proxy asking for the solution method is provided by the other user. Further, the plug-in application 224 transmits, to the client PC 140 of the inquiry user, information to the effect that the proxy asking for the solution method is provided.

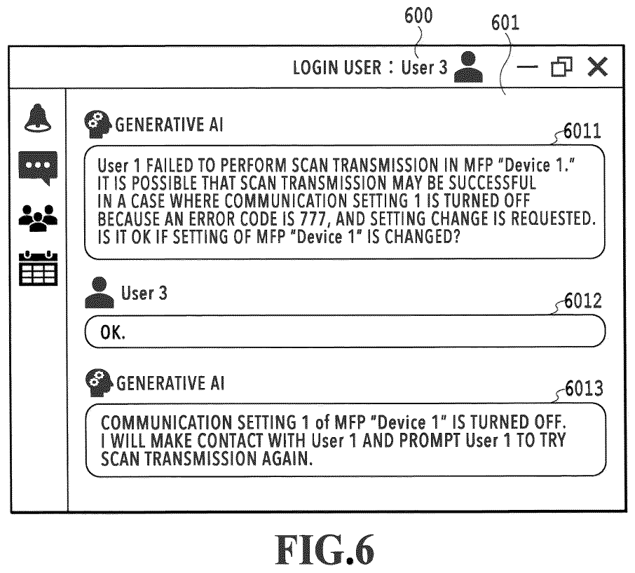

In S418, the generative AI client application 241 of the client PC 140 of the authority user displays, based on the information received from the generative AI cloud 120, a message to the effect that the proxy asking for the solution method is provided from the other user on the UI screen. Further, from the authority user, an instruction to execute the solution method is received. FIG. 6 is an example of a UI screen on which the generative AI client application 241 sounds out the authority user about the proxy asking for the solution method, and in a user name area 600, “User 3,” the user name of a user who logs in, is displayed. Further, a message 6011 indicating the contents of the proxy asking is displayed in a prompt area 601 on the UI screen of FIG. 6 at the time of the present step. Further, in a case where the authority user consents to execute the solution method as a proxy, the authority user inputs text information 6012 as a prompt to that effect. The generative AI client application 241 which receives such an input transmits the instruction to execute the solution method to the generative AI cloud 120. Incidentally, the authority user who receives the proxy asking may ask a question by inputting text information (for example, “are not other users influenced even in a case where the settings are changed?”) for a status check into the prompt area 601 before the authority user consents to execute the solution method as a proxy. In a case where an answer message to the question, for example, “other users are influenced” is displayed, it is possible that the authority user refuses to execute the solution method as a proxy. In a case where the authority user refuses to execute the solution method as a proxy, the generative AI client application 241 makes a response to the effect that proxy asking is refused to the generative AI cloud 120.

In S419, the generative AI client application 241 of the client PC 140 of the inquiry user displays, based on the information received from the generative AI cloud 120, a message to the effect that the authority user is requested to execute the solution method as a proxy on the UI screen. In the example in FIG. 5 mentioned above, a message 5017 to the effect that the proxy asking is provided to the authority user is displayed in the prompt area 501 at the time of the present step.

In S420, the plug-in application 224 of the generative AI cloud 120 transmits the execution request to execute the solution method to the diagnosis cloud 100. Here, in a case of the execution request via S413, a credential of the inquiry user is used, and in a case of the execution request via S418, a credential of the authority user is used. As a result of this, it is possible to check (user authentication) on the side of the diagnosis cloud 100 which receives the execution request that the user who requests the execution of the solution method has the execute authority to execute the solution method by referring to the user table and the authority table. Further, in S421, the device diagnosis application 202 of the diagnosis cloud 100 executes the solution method (the setting change and the reboot of the device) according to the request via the action module 206 based on the received execution request. In the above specific example, a setting change to “turn off communication setting 1” is performed in the MFP 160 based on the instruction from the diagnosis cloud 120. In subsequent S422, the device diagnosis application 202 returns the execution results of the solution method to the generative AI cloud 120.

In S423, the plug-in application 224 of the generative AI cloud 120 receives the execution results of the solution method and transfers the execution results of the solution method to the generative AI application 222. Further, in S424, the generative AI application 222 returns the execution results of the solution method received from the plug-in application 224 to respective client PCs 140 of the authority user and the inquiry user.

In S425, the generative AI client application 241 of the client PC 140 of the authority user displays the execution results of the solution method received from the generative AI cloud 120 on the UI screen. In the example in FIG. 6 mentioned above, a message 6013 indicating the execution results of the solution method and indicating that the fact that the solution method has been executed will be reported to the inquiry user is displayed in the prompt area 601 at the time of the present step. On the other hand, in S426, the generative AI client application 241 of the client PC 140 of the inquiry user displays the execution results of the solution method received from the generative AI cloud 120 on the UI screen. In the example in FIG. 5 mentioned above, a message 5018 indicating the execution results of the solution method and prompting for the re-execution of a job is displayed in the prompt area 501 at the time of the present step. The above is a series of operations of the device diagnosis system according to the present embodiment.

### <Modification Example>

Incidentally, it is assumed in the above embodiment that the solution method is executed as a permanent solution to the trouble occurring in the MFP 160. However, in a case where a solution method according to proxy asking is, for example, setting change of the device, the solution method may be executed as a temporary measure (for example, after a predetermined time period elapses, the setting is automatically returned to the setting before the change) in consideration of an influence or the like on other users or the like. Further, it is considered that the authority user does not handle anything at all even in a case where a predetermined time period elapses after the proxy asking for the solution method is provided. In such a case, subsequent processes may be suspended. Alternatively, for example, the authority user may be made to perform rollback as necessary after the plug-in application 224 makes the execution request for the setting change without following the instruction provided by the authority user. In such a case, a message prompting for rollback has only to be displayed or the like on the UI screen. Further, in the present embodiment, in a case where the proxy asking is provided from the inquiry user, the proxy asking is provided to the authority user via the UI screen which is displayed by the generative AI client application, but the present disclosure is not limited to this. For example, in a case where the authority user does not log in the generative AI cloud 120 or the like, proxy asking may be provided to the authority user by using a chat function of a Web meeting application such as Teams and Zoom or e-mail. Furthermore, the inquiry user may provide an instruction to execute the solution method on behalf of the authority user by obtaining consent to the execution of the solution method from the authority user. In the execution request (S420) to execute the solution method based on the instruction to execute the solution method in this case, a credential as the authority user is used. Further, in the present embodiment, the troubleshooting support for the device is provided by the generative AI application by function enhancement which is—achieved by using a plug-in, but a device diagnosis function may be integrated in the generative AI cloud itself. Furthermore, it is assumed in the present embodiment that the inquiry user and the authority user access the same generative AI cloud, but the inquiry user and the authority user access different generative AI clouds respectively and cooperate with each other between the generative AI clouds.

As mentioned above, according to the present embodiment, in a case where the troubleshooting support for the device such as the MFP is provided by using the generative AI, it is possible to smoothly realize the solution necessary to resolve the trouble while a plurality of users cooperate with each other seamlessly.

### Embodiment 2

In Embodiment 1, the diagnosis cloud starts diagnosing the device as a result of the generative AI cloud directly receiving the inquiry from the user who is involved in the trouble in the device. Next, an aspect in which a diagnosis cloud automatically detects trouble occurring in a device which is a pre-registered monitor target and then automatically performs a diagnosis and notifies a user assumed to be involved in the trouble of the occurrence of the trouble and a solution method for solving the trouble via a generative AI cloud is described as Embodiment 2. Incidentally, the system configuration/hardware configuration of a device diagnosis system, various tables which are managed by the database module 208 of the diagnosis cloud 100, and applicable modifications are identical to those of Embodiment 1, and thus descriptions thereof are omitted. Hereinafter, an explanation is mainly made on the software configuration and the operation sequence which are different from those of Embodiment 1.

### <Software Configuration>

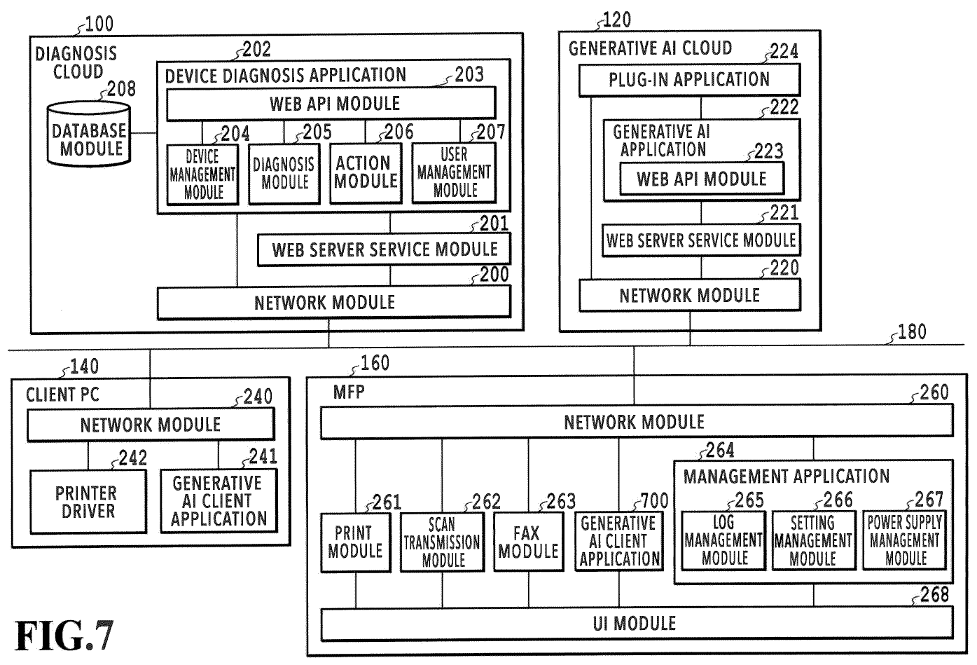

FIG. 7 is a block diagram illustrating the software configuration of a device diagnosis system according to the present embodiment. The software configuration of the device diagnosis system according to the present embodiment is different from the software configuration of the device diagnosis system according to Embodiment 1 in that the MFP 160 has an AI client application 700. The generative AI client application 700 transmits an HTTP request message to the generative AI cloud 120 via the network module 260 and receives an HTTP response message from the generative AI cloud 120 and displays the HTTP response message. Access to the generative AI cloud 120 from the MFP 160 is made through the generative AI client application 700.

### <Operation Sequence of Device Diagnosis System>

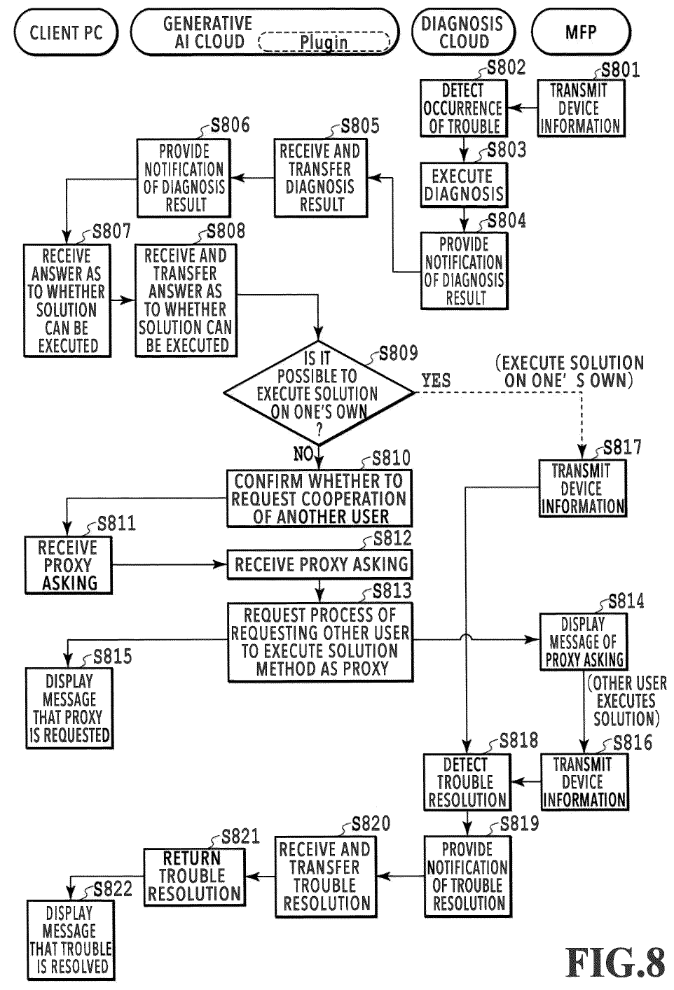

Next, by using a sequence diagram in FIG. 8, the operation of the device diagnosis system according to the present embodiment is described. In the following descriptions, an explanation is made by using, as an example, a situation in which a user instructs the MFP 160 which is pre-registered as a diagnosis target device of the device diagnosis cloud to print a document from a client PC of the user but printing fails to be performed because of paper jam. Incidentally, the symbol “S” means a step in the following descriptions.

In S801, the MFP 160 transmits device information and log information to the device diagnosis application 202 of the diagnosis cloud 100. The transmission is performed in response to a regular obtainment request made by polling or the like from the device diagnosis cloud 100 or by using push communication caused by the occurrence of a job error in the MFP 160. The received device information and log information are stored in a device information table and a log table of the database module 208 via the device management module 204.

In S802, the device diagnosis application 202 of the diagnosis cloud 100 refers to the device information table and/or the log table via the device management module 204 and performs a detection process to detect whether trouble occurs in the diagnosis target device. For example, in a case where the device information table becomes the contents of FIG. 3A mentioned above, the occurrence of “Paper Jam” meaning a paper jam error is automatically detected in the MFP 160 whose device ID is “5.” In a case where the occurrence of the trouble is detected in this way, the device diagnosis application 202 refers to the log table and then identifies a user (hereinafter referred to as “factor user”) who inputs a job which becomes a factor of the detected trouble. Here, the user with the user name “User 1” who inputs a print job at a time at which the paper jam occurs in the MFP 160 whose device ID is “5” is identified as a factor user.

Then, in S803, the device diagnosis application 202 diagnoses the detected trouble. Specifically, with reference to a diagnosis logic table of the database module 208 via the device management module 204, a solution method corresponding to the detected trouble is obtained. In the example of the diagnosis logic table in FIG. 3C mentioned above, “Open paper feeds and remove any stuck pieces” is obtained as a solution method corresponding to the status “Paper Jam.” In this way, in a case where a diagnosis result corresponding to the trouble is obtained, the device diagnosis application 202 transmits information on the contents of the detected trouble, the solution method for solving the detected trouble, the user name of the factor user, and the like to the generative AI cloud 120 as a diagnosis result in S804.

In S805, the plug-in application 224 of the generative AI cloud 120 receives the diagnosis result and transfers the diagnosis result to a generative AI application 222. Then, in S806, the generative AI application 222 transmits the diagnosis result received from the plug-in application 224 to the client PC 140 of the factor user. Incidentally, the factor user logs in the generative AI cloud 120 from the client PC 140 of the factor user.

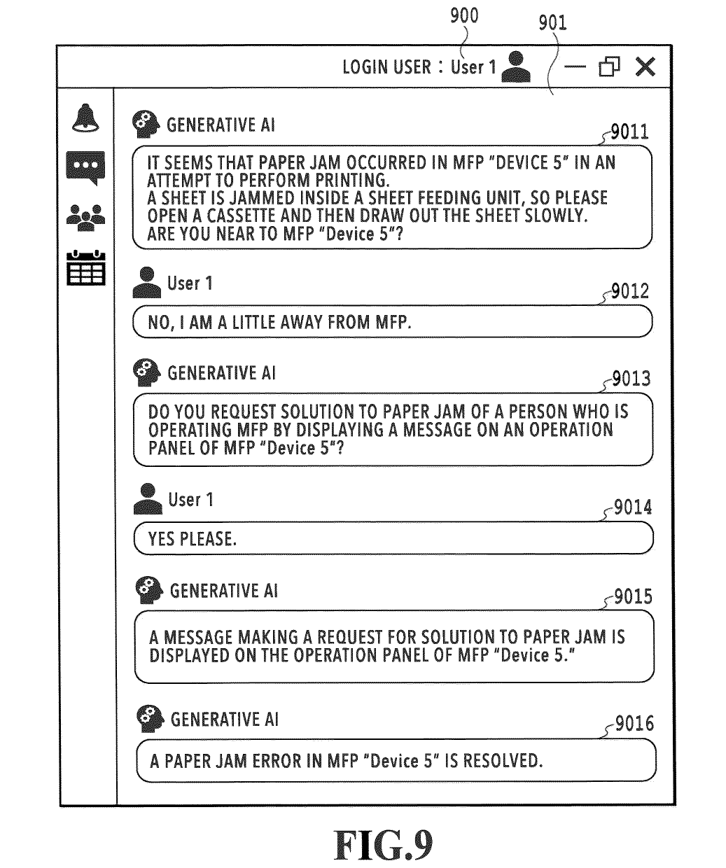

In S807, the generative AI client application 241 of the client PC 140 presents the contents of the diagnosis result received from the generative AI cloud 120 to the factor user. Specifically, a UI screen including a message indicating the contents of the trouble and the solution method for solving the trouble is displayed on the display of the client PC 140 of the factor user. FIG. 9 shows an example of a UI screen on which the generative AI client application 241 provides troubleshooting support, and the user name “User 1” of the factor user is displayed in a user name area 900. Further, the contents of the detected trouble, the solution method for solving the detected trouble, and further a message 9011 inquiring whether the user can handle the detected trouble on the user's own are displayed in a prompt area 901 of the UI screen in FIG. 9 at the time of the preset step. Here, in a case where it is easy for the factor user to handle the detected trouble because the factor user is near to the MFP 160 of “Device 5,” text information (for example, “Yes, I am near to the MFP”) to that effect is entered. On the other hand, in a case where the factor user is not near to the MFP 160 of “Device 5” and it is difficult for the factor user to handle the detected trouble on the factor user's own, text information 9012 to that effect is entered. The generative AI client application 241 which receives such a user input transmits the user input to the generative AI cloud 120 as an answer as to whether the solution can be executed.

In S808, the generative AI application 222 of the generative AI cloud 120 receives the answer as to whether the solution can be executed from the client PC 140 of the inquiry user and transfers the answer to the plug-in application 224. Then, in S809, the plug-in application 224 performed S810 next based on the received answer as to whether the solution can be executed in a case where it is impossible for the factor user to handle the detected trouble. On the other hand, in a case where the factor user can handle the detected trouble on the factor user's own, a necessary measure (here, the operation of removing a jammed sheet) is performed by the factor user. Further, S817 mentioned below is performed in the MFP 160.

In S810, the plug-in application 224 make a response to the effect that the intention confirmation as to whether the inquiry user requests another user to execute the solution as a proxy is required to the client PC 140 of the factor user. In S811, the generative AI client application 241 of the client PC 140 of the factor user displays, on the UI screen based on a response from the generative cloud 120, a message to the effect that whether the other user is requested to execute the solution as a proxy is confirmed. Then, an instruction for proxy asking from the factor user is received. In the example in FIG. 9 mentioned above, a message 9013 is displayed in the prompt area 901 at the time of the present step. Then, in a case where the factor user wishes to request the other user to execute the solution as a proxy, the factor user inputs text information 9014 to that effect. The factor user can request the other user to execute the solution method as a proxy via such a UI screen. In this way, the instruction for the proxy asking for the solution method is received from the factor user, and the generative client application 241 transmits proxy asking to the generative AI cloud 120.

In 812, the plug-in application 224 of the generative AI cloud 120 receives the proxy asking from the client PC 140 of the factor user. In subsequent S813, the plug in application 224 transmits an execution request to execute a process of requesting the other user to execute the solution method as a proxy to the MFP 160. Furthermore, the plug-in application 224 transmits, to the client PC 140 of the factor user, information to the effect that the process of requesting the other user to execute the solution method as a proxy is executed.

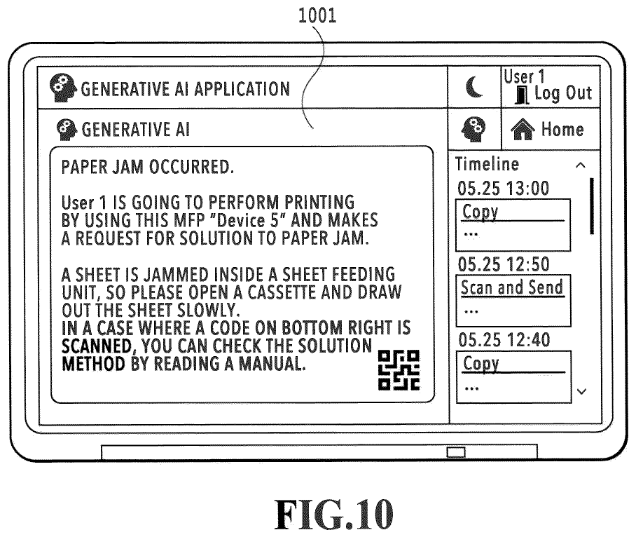

In S814, the generative AI client application 700 of the MFP 160 displays, on an operation unit 166 based on the information received from the generative AI cloud 120, a UI screen including a message to the effect that a request to handle the trouble is received from a user. FIG. 10 is an example of a UI screen on which the generative AI client application 700 sounds out a user about the solution to the trouble. Here, a message indicating the contents of the proxy asking is displayed in a message area 1001 of the UI screen in FIG. 10. Further, in S815, the generative AI client application 241 of the client PC 140 of the factor user displays, on the UI screen based on the information received from the generative AI cloud 120, a message to the effect that the other user is requested to execute the solution method as a proxy. In the example in FIG. 9 mentioned above, a message 9015 to the effect that the proxy asking is provided to the other user is displayed in the prompt area 901 at the time of the present step. Then, in a case where the solution to the trouble is executed by the other user who views such a UI screen which is displayed in the operation unit 166 of the MFP 160, in S816, the MFP 160 transmits the device information and the log information to the device diagnosis application 202 of the diagnosis cloud 100. Further, in a case where a necessary measure (removal of a jammed sheet or the like) is performed by the factor user, in S817, the MFP 160 transmits the device information and the log information to the device diagnosis application 202 of the diagnosis cloud 100. Both transmissions in S816 and S817 are performed in response to a regular obtainment request made by polling or the like from the device diagnosis cloud 100 or by push communication caused by the detection of the resolution of the trouble in the MFP 160. Then, in the diagnosis cloud 100, a process of reflecting the received device information and the received log information in the device information table and the log table of the database module 208 via the device management module 204 is performed.

In S818, the device diagnosis application 202 of the diagnosis cloud 100 refers to the device information table and/or the log table via the device management module 204, and a detection process of detecting whether the trouble is resolved in the diagnosis target device in which the trouble occurs is performed. In a case where the resolution of the trouble is detected, in S819, the device diagnosis application 202 transmits a notification of trouble resolution to the generative AI cloud 120. Incidentally, in a case where the solution method necessary to resolve the trouble is not executed even though a predetermined time period elapses, a notification of information to that effect is provided as a result of the proxy asking.

In S820, the plug-in application 224 of the generative AI cloud 120 receives a notification of the resolution of the trouble and transfers the notification of the resolution of the trouble to the generative AI application 222. Then, in S821, the generative AI application 222 transmits information to the effect that the trouble is resolved to the client PC 140 of the factor user.

In S822, the generative AI client application 241 of the client PC 140 of the factor user displays, based on the information received from the generative AI cloud 120, a message to the effect that the trouble is resolved on the UI screen. In the example of FIG. 9 mentioned above, a message 9016 which reports the resolution of the trouble is displayed in the prompt area 901 at the time of the present step.

The above is a series of operations of the device diagnosis system according to the present embodiment. Incidentally, in the present embodiment, the other user who is operating the MFP 160 in which the trouble occurs is requested to execute the solution method as a proxy, but the present disclosure is not limited to this. For example, the plug-in application 224 of the generative AI cloud 120 may obtain information on a user who is executing a job in the MFP 160 in which the trouble occurs and then directly request the user to execute the solution method as a proxy.

Also in a case of the present embodiment as in Embodiment 1, it is possible to smoothly realize the necessary solution to resolve the trouble while a plurality of users cooperate with each other seamlessly in a case where the troubleshooting support for the device is provided by using the generative AI.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the technique in the present disclosure, in the troubleshooting support for the device by using the generative AI, it is possible to realize a necessary solution without a hitch.

This application claims the benefit of Japanese Patent Application No. 2024-174550, filed Oct. 3, 2024 which is hereby incorporated by reference herein in its entirety.

What is claimed is:

1. A storage medium storing an application program providing troubleshooting support service for a device by using generative AI,
the application program causing a computer to perform the steps of: obtaining a solution method for solving trouble occurring in the device;
in a case where a first user involved in the trouble who has received presentation of the solution method is unable to handle the solution method on the first user's own, receiving an instruction for proxy asking for the solution method from the first user; and
requesting, based on the received instruction, a second user different from the first user to execute the solution method as a proxy.

2. The storage medium according to claim 1, wherein the generative AI application program further causes the computer to perform receiving an inquiry about the trouble from the first user, wherein
the solution method is obtained based on the received inquiry.

3. The storage medium according to claim 1, wherein the second user is a user who has execute authority to execute the solution method in a case where the first user does not have the execute authority to execute the solution method.

4. The storage medium according to claim 3, wherein
the application program further causes the computer to perform searching for a user who has the execute authority; wherein
the second user is a user who is designated by the first user among users who are searched for and have the execute authority.

5. The storage medium according to claim 4, wherein the second user is a user who is designated by the first user among users who can act as a proxy to execute the solution method of the users who are searched for and have the execute authority.

6. The storage medium according to claim 4, wherein the second user is a user who is designated by the first user among the users who are searched for and have the execute authority, and the second user is confirmed to be reliable in terms of security.

7. The storage medium according to claim 1, wherein
the application program further causes the computer to perform the steps of:
obtaining device information including a status of the device; and
detecting trouble occurring in the device based on the obtained device information, wherein
the solution method is obtained based on detection of the trouble in the detecting.

8. The storage medium according to claim 7, wherein the second user is a user who can easily execute the solution method in a case where the first user has difficulty in executing the solution method.

9. The storage medium according to claim 7, wherein the second user is a user who is operating the device or is near to the device.

10. The storage medium according to claim 9, wherein
the application program further causes the computer to perform identifying the second user, wherein
the identified second user is directly requested to execute the solution method as a proxy.

11. The storage medium according to claim 1, wherein, in the requesting, it is shown to the second user that the request is based on the instruction for proxy asking is provided by the first user.

12. The storage medium according to claim 1, wherein the application program further causes the computer to perform responding to the first user by returning an execution result of the solution method based on handling performed by the second user who has been requested to execute the solution method as a proxy.

13. The storage medium according to claim 1, wherein the solution method is any of a setting change, an operation, and a reboot of the device.

14. The storage medium according to claim 13, wherein, in a case where the solution method is the setting change of the device, the application program further causes the computer to execute a process of automatically returning to a setting before the setting change after a predetermined time period elapses.

15. The storage medium according to claim 13, wherein, in a case where the second user does not handle the requesting even after a predetermined time period elapses from the requesting the second user to execute the solution method as a proxy in a case where the solution method is the setting change of the device, the application program further causes the computer to perform the steps of:
executing the setting change; and
after the setting change is executed, executing a process of prompting the second user to perform rollback which returns the changed setting to an original state.

16. The storage medium according to claim 1, wherein the device is a printer.

17. An information processing system comprising a server apparatus which provides troubleshooting support service for a device by using generative AI and a client device to use the troubleshooting support service provided by the server apparatus,
the server apparatus comprising:
one or more memories storing instructions; and
one or more processors executing the instructions to:
receive an inquiry about trouble occurring in the device from a first user;
obtain a solution method for solving the trouble occurring in the device based on the received inquiry;
in a case where the first user who has received presentation of the solution method is unable to handle the solution method on the first user's own, receive an instruction for proxy asking for the solution method from the first user; and
request, based on the received instruction, a second user different from the first user to execute the solution method as a proxy.

18. An information processing system comprising a server apparatus which provides troubleshooting support service for a device by using generative AI and a client device to use the troubleshooting support service provided by the server apparatus,
the server apparatus comprising:
one or more memories storing instructions; and
one or more processors executing the instructions to:
obtain device information including a status of the device;
detect trouble occurring in the device based on the obtained device information;
obtain a solution method for solving trouble occurring in the device based on the detecting of the trouble;
in a case where a first user who has received presentation of the solution method is unable to handle the solution method on the first user's own, receive an instruction for proxy asking for the solution method from the first user; and
request, based on the received instruction, a second user different from the first user to execute the solution method as a proxy.

19. A method for providing troubleshooting support service for a device by using generative AI, the method causing a computer to perform the steps of:
obtaining a solution method for solving trouble occurring in the device;
receiving, in a case where a first user involved in the trouble who has received presentation of the solution method is unable to handle the solution method on the first user's own, an instruction for proxy asking for the solution method from the first user; and
requesting, based on the received instruction, a second user different from the first user to execute the solution method as a proxy.
